(19) United States
(12) Patent Application Publication
(10) Pub. No.: US 2019/0117015 A1
(43) Pub. Date: Apr. 25, 2019

(54) GRILL

(71) Applicant: OUTDOORCHEF AG, Zürich (CH)

(72) Inventor: Andre BITTEL, Auw (CH)

(73) Assignee: OUTDOORCHEF AG, Zürich (CH)

(21) Appl. No.: 16/093,183

(22) PCT Filed: Apr. 5, 2017
(86) PCT No.: PCT/IB2017/051947

§ 371 Date: Oct. 12, 2018

(30) Foreign Application Priority Data
Apr. 13, 2016 (CH) 0482/16

(51) Int. Cl. A47J 37/06; A47J 37/07

(52) U.S. Cl. CPC A47J 37/0694; A47J 37/0704

(57) ABSTRACT

A grill such as a gas grill for grilling, cooking or baking food on a grill grate or the like, in particular for outdoor use. It has a combustion chamber, in which a burner arrangement is provided. The combustion chamber is provided with a hinged hood which covers the grill grate in the closed state. A simple and reliable conversion between direct and indirect grilling is achieved and enables a simultaneous and energy-saving direct and indirect grilling. The grill is provided with a guide plate, which is designed in the direction of a main axis of the combustion chamber in any width and which covers at least a part of the burner arrangement. The guide plate extends between front side and rear wall of the combustion chamber and supported on inner edges of the combustion chamber.

The invention relates to a grill, for example, a gas grill according to the preamble of claim 1 for grilling, cooking or baking food on a grill grate or the like, in particular for outdoor use. It has a combustion chamber in which a burner arrangement is provided, wherein the combustion chamber is provided with a hinged hood, which covers a grill grate in the closed state.

Grills and gas grills for cooking grilled food or food have at least one grill body having a grill grate or the like for supporting the grilled food and means for heat generation underneath, in particular glowing charcoal, pellets, heating elements or gas burners. Depending on the equipment of the grilling device, a lid or a hood for closing the grill body is further provided. In simple grills, the lid is separated from the grill body and can be loosely placed. In many grills, the lid is connected as a hinged lid but fixedly to the grill body.

A grill for outdoor use is known from EP 0653917 B1, in which a wall is used between a heat source, in particular a gas burner ring in the lower region of a grill container and a grate for supporting the grilled food, which prevents drops from the grilled food, in particular fat or water, to the heat source and catches such drops collecting above the heat source. The drops are directed into a container arranged below the heat source. In this case, those regions of the wall which cause evaporation of drops due to their temperature are arranged inclined at an angle of 30° to 70° to the horizontal. The wall is formed in the shape of spherical shell sections. It includes guiding means which direct the drops into a central recess region of the heat source and from there into a container arranged below the heat source.

In a gas grill according to DE 202012100587 U, a grease collecting device is arranged below a burner unit, which collecting device comprises a plurality of grease collecting pans located side by side. A similar solution is disclosed in U.S. Pat. No. 4,909,137A. Likewise, drainage angles (DE 08804071 U) or channels (DE 2020099014563 U) can be used instead of pans.

In another grill of this type, a device for heat conduction is provided, which enables cooking operations with direct and indirect heat management. When directly grilling, the heat of the heat source with the lid open is conducted directly to the grilled food to be cooked, while in indirect grilling, the heat from the heat source is laterally guided around the grilled food by means of a heat conduction device and only reaches the grilled food by deflection under the closed lid. The grill body has an insert with closable openings to switch between direct and indirect heat management. By means of a handle externally guided on the grill body, which handle is connected to the insert, the open and closed position of the openings can be achieved. In addition, DE 202014004089 U proposes a burner cover made of V-shaped angled elements for a homogeneous heat distribution which covers the entire burner space.

To improve the grill performance, burners or radiant heaters can also be arranged laterally to the grill grate and/or different grill grates or grill chambers are provided for variable grilling.

The invention has the object to provide a grill for grilling, cooking or baking of food such as meat or fish on a grill grate or the like, in particular for outdoor use, which enables a simple and reliable conversion between direct and indirect grilling and direct and indirect grilling simultaneously and in an energy-saving manner.

The object is achieved with the features of patent claim 1.

According to the invention, a grill, for example a gas grill, has a specifically shaped guide plate which can be arranged without fastening elements on or in a combustion chamber of the grill and which is used in particular in conjunction with a rotary skewer.

The grill according to the invention is suitable for grilling, cooking or baking food such as meat, fish, dairy products, vegetables or baked goods on a grill grate or the like, in particular for outdoor use. The guide plate according to the invention enables a flavor enhancement of the grilled food.

Energy saving back burners or laterally arranged radiant heaters can be dispensed with due to the guide plate according to the invention. In addition to saving gas or energy, this also improves work safety safety during grilling.

The guide plate according to the invention is easy to clean and can be inserted without the use of tools and can be removed from the gas grill so that it can be cleaned in a dishwasher.

Preferred embodiments are disclosed in the dependent claims.

The guide plate is provided with recesses and drip elements, in which liquid from the cooked food can flow together and drain.

Furthermore, a separating plate that is also usable without tools is provided, which allows the simultaneous use of different cooking methods and which can also be used as a holder, for example, for a rotary skewer or trays.

The invention is described below in an embodiment in the form of a gas grill with reference to a drawing. Shown is the drawing are

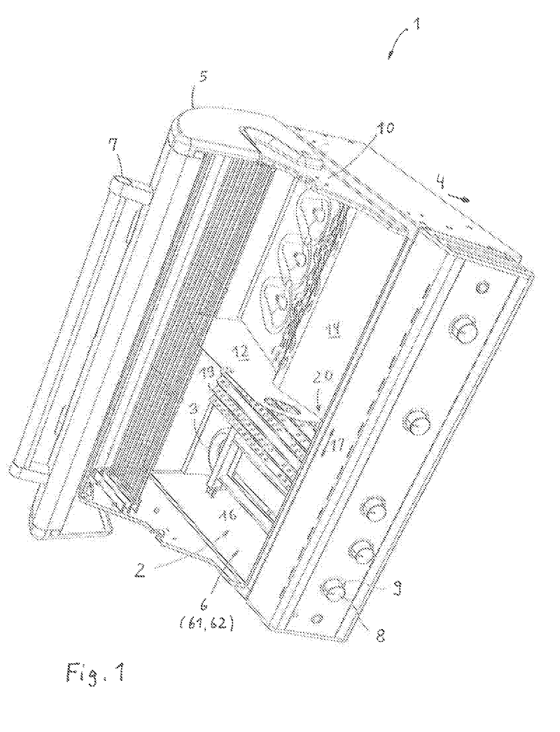

FIG. 1: a grill according to the invention in partial view,

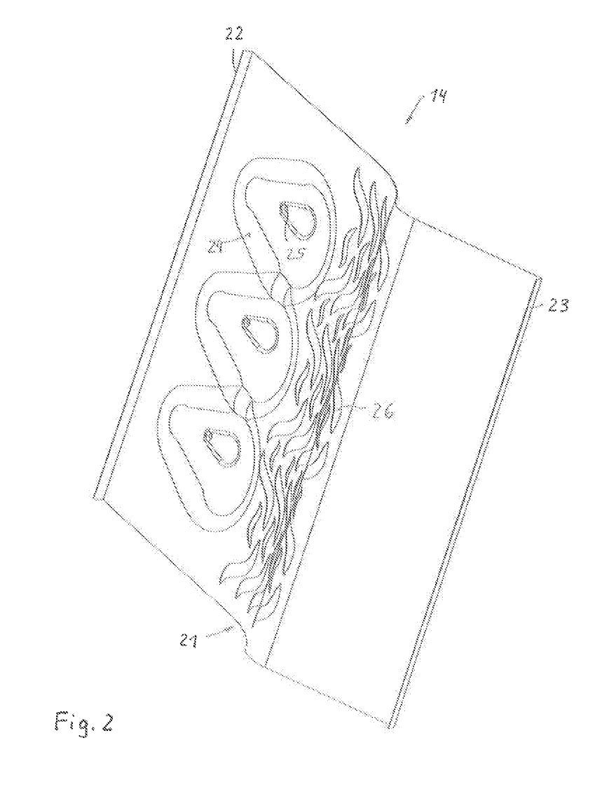

FIG. 2: a guide plate according to the invention for indirect grilling,

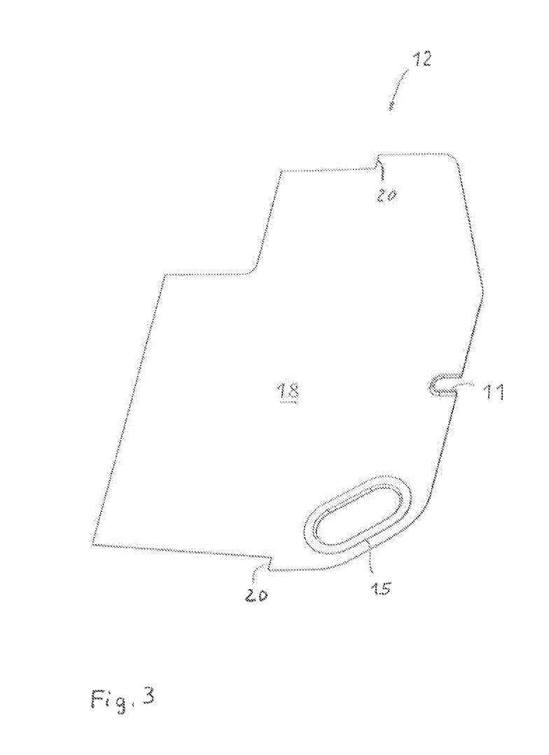

FIG. 3: a separating plate according to the invention,

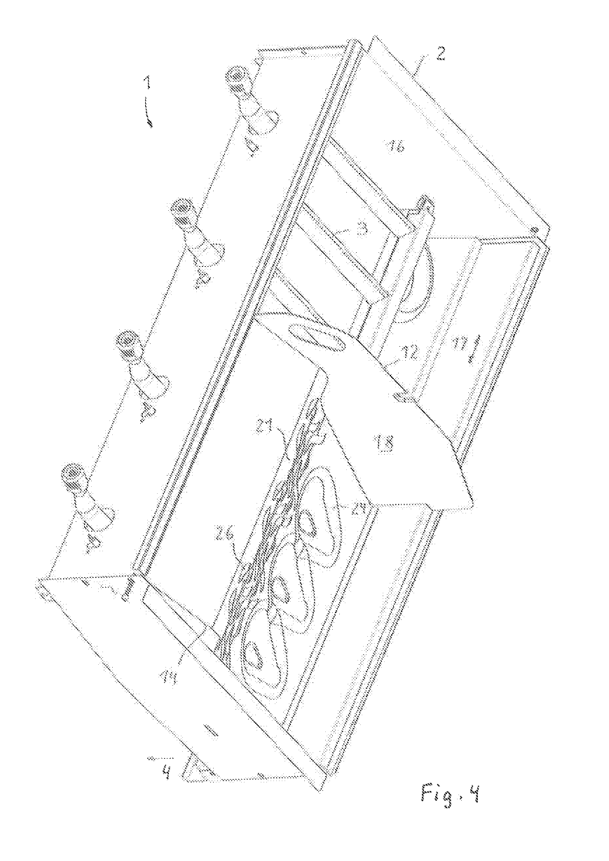

FIG. 4: the grill of FIG. 1 in rear view,

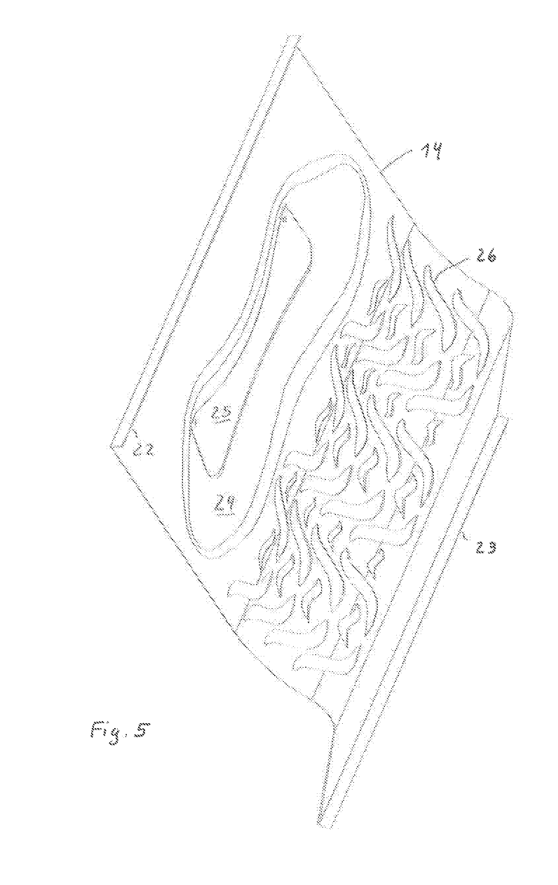

FIG. 5: the guide plate of FIG. 2 in another embodiment and

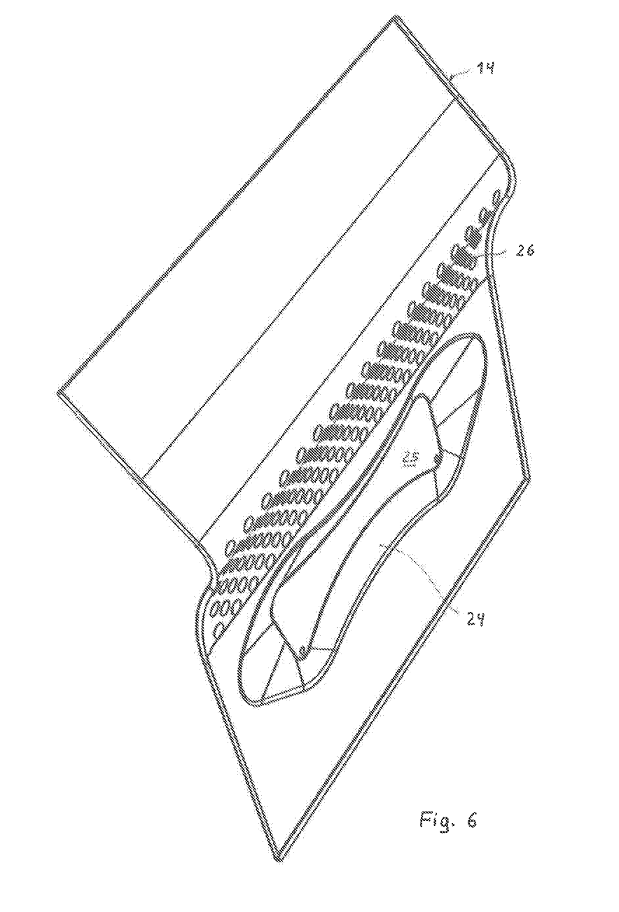

FIG. 6: the guide plate of FIG. 5 in a further embodiment.

A grill according to the invention, in the exemplary embodiment a gas grill 1 (FIG. 1), has a combustion chamber 2, in which a burner arrangement 3 is provided, wherein the combustion chamber 2 is provided with a hinged hood 5 which covers a grill grate 6 in the closed state. The hood 5 is hinged by means of hinge on the rear wall of the combustion chamber 2 or on side walls 10 surrounding the grill grate 6 on three sides. The hood 5 is provided with a handle 7 for opening and closing.

A flame protector 19 is still positioned between burners of the burner arrangement 3 and the grill grate 6, which flame guard is used to reduce the risk or the effects of burning fat mentioned above.

The combustion chamber 2 is arranged to sit on a possibly rollable underframe 4 and may have lateral, not shown, shelves for tableware or grilled food.

The burner arrangement 3 comprises at least one, for example, burner tube arranged as a ring or loop (in the simplest case, a straight burner tube) having outflow openings for a fuel gas.

The underframe 4 is used in a known manner, the accommodation of gas bottle, fittings, grilling tools, tableware, etc. and may be configured open or preferably closed by means of side walls and doors.

The combustion chamber 2 protrudes at least in at the front wall (front panel) facing the user, with the burners of the burner arrangement 3 in conventional design coupled rotary handle 8 for adjusting the burner power. The rotary handle 8 is surrounded by a light ring 9 in the form of colored LEDs in the front wall. This light ring 9 lights up as soon as a gas valve, not shown, is opened and the ignition device of the burner is active, in particular even before the outflow of gas. For this purpose, the ignition device can be coupled to the valve, for example, or with a separate “start button”.

Grill grates 6 of different types, both bar grates or grid grates or sheet grates, can be placed or inserted on or in the combustion chamber 2 above or spaced from the burner arrangement 3. The solid side walls 10 delimit the grill or grate surface, the hood 5 can guide laterally due to its shape and can also have receptacles 11 for a rotary skewer mentioned above.

Furthermore, the gas grill 1 is provided with a guide plate 14 (DGS heat diffuser, wherein DGS stands for Dual Gourmet System), which in the direction of the main axis 17 of the gas grill 1 covers at least a part of the burner arrangement 3 and the flame protector 19 for the purpose of indirect heat or indirect heat management. In principle, however, it can be designed in any width. Also like a separating plate 12, it lies on the inner edges of the combustion chamber 2.

The guide plate 14 has no fastening elements for connection to the combustion chamber 2 mentioned above and can be loosely laid on or in (FIGS. 1, 2, 5 and 6).

The guide plate 14 extends between front side and rear wall of the combustion chamber 2, with an inclination increasing starting from the front side (or vice versa from the back side) with respect to the combustion chamber 16 to a rounded region 21 and falls off again after the rounded region 21, and if necessary, may slightly increase again up to the support on the rear side wall (or vice versa to the front side wall).

Edges 22, 23 of the guide plate 14 are angled at the support points perpendicular to the main surface of the guide plate 14, preferably folded by up to 90°, folded upward on the rear wall and folded downward on the front side. Thus, the rear wall-side edge 23 can be used at the same time as a collection and drainage channel for liquid released during grilling, from which the liquid in turn passes to a collector plate located underneath. The guide plate 14 is provided with at least one or more, preferably two or three recesses 24 (collecting recess) between the front-side edge 22 and the rounded region 21, which recesses have at least one opening 25 at the lowest point. The substantial amount of liquid released during grilling is collected in these recesses 24 and this liquid can drain through the openings 25 on fat drainage channels, not shown, and the collecting sheet. In the rounded region 21, the guide plate 14 has a plurality of openings or slots 26, is guided by the hot air concentrated on the grilled food, similar to a back-wall radiator. The slots 26 are preferably arranged horizontally in their longitudinal extent.

In a further embodiment, instead of a plurality of recesses 24, for example, a single, large recess 24, with likewise only one opening 25, may be formed on the guide plate 14 (FIG. 6). Likewise, the openings 26 may, for example, be round or circular instead of slot-shaped.

The grill grate 6 is preferably removed for insertion of the guide plate 14 (and placed back again after the removal of the guide plate 14).

The guide plate 14 is used in particular in conjunction with a rotary skewer application that can be arranged rotatably mounted between the side walls 10 or a side wall 10 and the separating plate 12. The guide plate 14 is therefore shaped such that the grilled food to be rotated has as uniform as possible distance from the guide plate 14 in the rounded region 21 and in the rising region above the recesses 24.

The guide plate 14 allows energy-saving, indirect cooking of grilled food and acts as a flavor enhancer for the grilled food as a result of hot air guidance through the slots 26 and from liquid evaporating in the recesses 24.

An insertable separating plate 12 (DGS zone divider) may be provided parallel to the fixed side walls 10, which plate can divide the grill surface and which is guided on the combustion chamber 2. In the exemplary embodiment, it is supported on the inner edge of the combustion chamber 2. For this purpose, shoulders 20 are formed as support and positioning aids on the separating plate 12. The separating plate 12 extends below the grill grate 6, see FIGS. 3 and 4. The separating plate 12 is provided with an opening for engagement of fingers or a hand. If necessary, the separating plate 12 may additionally have a web extending horizontally and on both sides to its main surface 18 and along the extension between the shoulders 20. With this optional web, the separating plate 12 could then be supported on the edge regions of two adjacent grates 61, 62 or an inner edge of the combustion chamber 2.

With or without web, the separating plate 12 extends further below the grate surface, possibly to the burner arrangement 3, and is guided in the gap between the grates 61, 62. Likewise, it is also possible to provide receptacles 11 (storage) on the separating plate 12 for a rotary skewer mentioned above and a gripping opening 15 in the main surface 18.

Instead of a burner arrangement 3, an electric heating rod can be used as a heat source, with appropriate structural adjustment and charcoal, briquettes, pellets or other combustible, organic substances.

### LIST OF REFERENCE NUMBERS

1 gas grill

2 combustion chamber

3 burner arrangement

4 underframe

5 hood

6 grill grate

7 handle

8 rotary handle

9 light ring

10 side wall

11 receptacle

12 separating plate

14 guide plate

15 gripping opening

16 combustion chamber

17 main axis

18 main surface

19 flame protector

20 shoulder

21 region

22 edge

23 edge

24 recess

25 opening

26 slot

61 grate

62 grate

1-10. (canceled)

11. A grill for grilling, cooking or baking food on a grill grate or the like, the grill comprising a combustion chamber in which a burner arrangement is provided, wherein the combustion chamber is provided with a hinged hood which covers the grill grate in a closed state, wherein the grill is provided with a guide plate that can be designed in a direction of a main axis of the combustion chamber in any width and thereby covers at least a part of the burner arrangement, wherein the guide plate is configured extending between front side and rear wall of the combustion chamber and is configured supported on inner edges of the combustion chamber in such a way that the guide plate, starting from a front side of the combustion chamber, passes into a rounded region with increasing inclination, to which a further inclined region is attached.

12. The grill according to claim 11, wherein the guide plate is configured such that the guide plate, starting from a front side of the combustion chamber, passes into a rounded region with increasing inclination, to which a further inclined region is attached, or done in the opposite direction.

13. The grill according to claim 12, wherein the inclined regions are straight or slightly curved.

14. The grill according to claim 11, wherein the inclined regions are folded at an angle at support points towards the combustion chamber.

15. The grill according to claim 14, wherein edges of the guide plate are folded by up to 90° at the support points toward the main surface of the guide plate.

16. The grill according to claim 11, wherein the guide plate is provided between the front-side edge and the rounded region with at least one or more recesses, which have at least one opening at a lowest point.

17. The grill according to claim 11, wherein the guide plate has a plurality of openings or slots in the rounded region.

18. The grill according to claim 11, wherein the grill is provided with a separating plate dividing the grill grate, which plate may additionally have a web extending perpendicularly and on both sides of its main surface, wherein the main surface also extends below the grill grate up to the burner arrangement.

19. The grill according to claim 11, wherein the grill is provided with at least one rotary handle for adjusting the burner power, which is associated with a light ring in the form of colored LED.

20. A guide plate for a grill, gas grill, electric grill, pellet or charcoal grill, which guide plate has a combustion chamber for a heat source, such as gas burners, electric heaters or charcoal, wherein the guide plate is configured extending between front side and rear wall of the combustion chamber and supported on inner edges of the combustion chamber, wherein the guide plate is configured such that the guide plate, starting from the front side of the combustion chamber, passes into a rounded region with increasing inclination, to which a further inclined region is attached, and wherein the inclined regions are folded at an angle at support points toward the combustion chamber, between a front-side edge and the rounded region is provided with at least one or more recesses, which has at least one opening at a lowest point, and wherein a plurality of openings or slots is provided in the rounded region.
